(19) United States
(12) Patent Application Publication
(10) Pub. No.: US 2016/0275666 A1
(43) Pub. Date: Sep. 22, 2016

(54) SEMICONDUCTOR DEVICE AND CAMERA APPARATUS

(71) Applicant: Kabushiki Kaisha Toshiba, Tokyo (JP)

(72) Inventor: Tomoyuki Okuyama, Inagi Tokyo (JP)

(21) Appl. No.: 14/847,244

(22) Filed: Sep. 8, 2015

(30) Foreign Application Priority Data
Mar. 16, 2015 (JP) 2015-052006

(51) Int. Cl. G06T 7/00; H04N 5/341; H04N 5/225

(52) U.S. Cl. CPC G06T 7/003; G06T 7/0081; H04N 5/225; H04N 5/341; G06T 2207/30201

(57) ABSTRACT

A semiconductor device in the present embodiment includes an image processing unit and an authenticating unit. The image processing unit acquires a captured image and can change a pixel value in the captured image. The authenticating unit authenticates the similarity between an object image included in the captured image and a reference image. The authenticating unit outputs coordinate information on the object image to an image processing unit, and authenticates the similarity between the object image, pixel values corresponding to the coordinate information on which are changed by the image processing unit, and the reference image.

### CROSS REFERENCE TO RELATED APPLICATIONS

This application is based upon and claims the benefit of priority from the prior Japanese Patent Application No. 2015-52006, filed on Mar. 16, 2015, the entire contents of which are incorporated herein by reference.

### FIELD

An embodiment of the present invention relates to a semiconductor device and a camera apparatus.

### BACKGROUND

In facial recognition systems, a face image of a person to be authenticated captured by a camera is searched for across dictionary data on face images that are accumulated in advance in a terminal. Then, it is determined whether there is a face image, among the face images in dictionary data, which matches the face image of the person to be authenticated.

However, in conventional facial recognition systems, the installation location of a camera or lighting conditions have a great influence on the accuracy of authentication, and it is thus necessary to constrain a use condition such as the installation location of the camera in order to secure the accuracy of authentication. For this reason, conventional facial recognition systems have a problem in that it is difficult to improve the convenience of recognition of an object based on a captured image.

### BRIEF DESCRIPTION OF THE DRAWINGS

FIG. 1 is a block diagram of an image processing system 1 illustrating the present embodiment; and

FIG. 2 is a flow chart showing the operation example of the image processing system 1.

### DETAILED DESCRIPTION

A semiconductor device in the present embodiment includes an image processing unit and an authenticating unit. The image processing unit acquires a captured image and can change a pixel value in the captured image. The authenticating unit authenticates the similarity between an object image included in the captured image and a reference image. The authenticating unit outputs coordinate information on the object image to an image processing unit, and authenticates the similarity between the object image, pixel values corresponding to the coordinate information on which are changed by the image processing unit, and the reference image.

Embodiments will now be explained with reference to the accompanying drawings. The present invention is not limited to the embodiments.

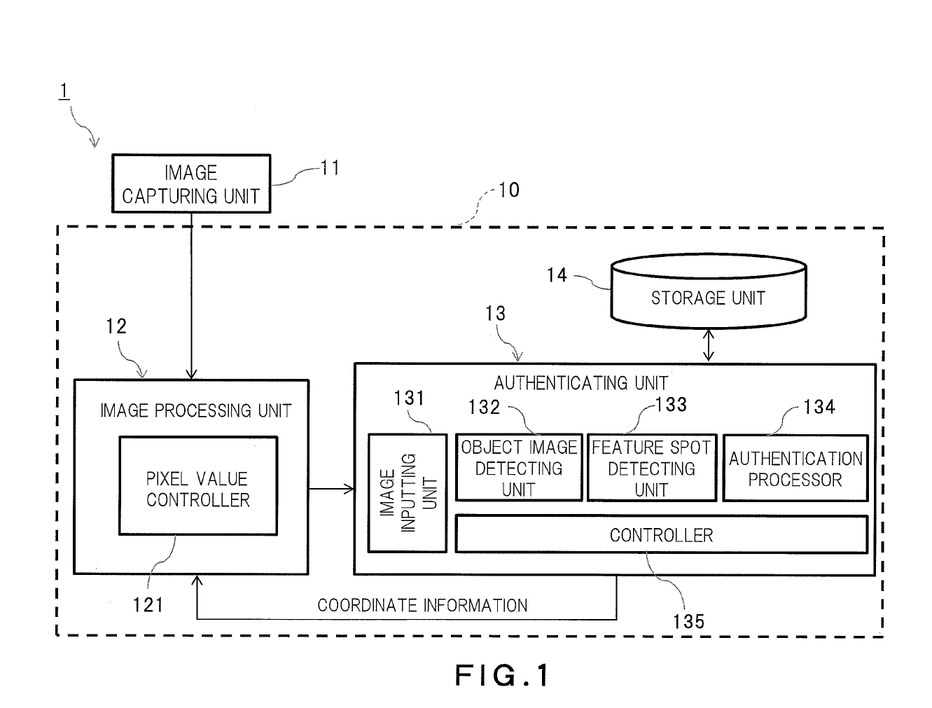

FIG. 1 is a block diagram of an image processing system 1 illustrating the present embodiment. The image processing system 1 in the present embodiment can be used for, for example, facial recognition to give permission to enter an installation. The image processing system 1 may be applied to uses other than the authentication of an object (confirmation of validity) (e.g., gesture inputting) as long as the uses are to authenticate (grasp) an object based on a captured image.

As shown in FIG. 1, the image processing system 1 includes an image capturing unit 11, an image processing unit 12, an authenticating unit 13, and a storage unit 14. In the storage unit 14, a reference image is stored, which is used for authentication processing to be described below.

The image processing system 1 in FIG. 1 is a camera apparatus (terminal). The image capturing unit 11, the image processing unit 12, the authenticating unit 13, and the storage unit 14 may be housed in a housing of a single camera. Furthermore, the image processing unit 12, the authenticating unit 13, and the storage unit 14 form a semiconductor device 10. The semiconductor device 10 may be an ISP (Image Signal Processor). According to the image transmitting system 1 in FIG. 1, the authentication processing to be described below can be implemented by a single camera (self-organization). Note that the image processing system in the present embodiment may be formed by a camera apparatus and an external device (e.g., server) that can communicate data with the camera apparatus.

The image capturing unit 11 captures an image of a subject and outputs captured image data on the subject to the image processing unit 12. The subject is, for example, a human face. The image capturing unit 11 is, for example, a camera module that is formed by lenses and a solid-state image sensing device. The solid-state image sensing device may be, for example, a CMOS area image sensor. The image capturing unit 11 may form a camera module together with the image processing unit 12. That is, the image processing unit 12 may be included in the camera module.

The image processing unit 12 includes a pixel value controller 121. The image processing unit 12 acquires captured image data from the image capturing unit 11 and inputs the acquired captured image data into the pixel value controller 121. The pixel value controller 121 can change (compensate, correct) pixel values in captured image data (i.e., pixel values in a captured image). The pixel values are, for example, luminance values. Note that a contrast can be changed by changing the difference between the maximum luminance value and the minimum luminance value of a captured image. The pixel value controller 121 may be able to change color difference values. The image processing unit 12 outputs the captured image data to the authenticating unit 13.

The authenticating unit 13 includes an image inputting unit 131, object image detecting unit 132, a feature spot detecting unit 133, an authentication processor 134, and a controller 135.

The image inputting unit 131 receives the captured image data output from the image processing unit 12.

The object image detecting unit 132 detects an object image contained in the captured image based on the captured image data received by the image inputting unit 131. Here, the object image is an image contained in the captured image, being an image to be subjected to the authentication processing to be described below.

For example, the object image is a face image of a human. The object image detecting unit 132 may detect an object image by detecting the contour of a face in an object image based on luminance differences. The object image detecting unit 132 calculates coordinate information on the object image.

The feature spot detecting unit 133 detects a predetermined feature spot in an object image. When the object image is a face image of a human, the feature spot may be an eye or a nose. The feature spot detecting unit 133 calculates coordinate information on an area of the feature spot.

The authentication processor 134 performs the authentication processing on an object image based on the feature spot of the object image detected by the feature spot detecting unit 133 and the reference image stored in the storage unit 14. Here, the authentication processing is a process of determining (judging) whether the feature spot of an object image contained in a captured image corresponds to the reference image. It can also be said that the authentication processing is a process of authenticating the similarity between the object image and the reference image. That is, the authentication processor 134 determines whether the object image contained in a captured image corresponds to the reference image. The reference image is an image, acquired (registered) in advance, for which the similarity with an object image is checked at the time of the authentication processing. For example, the reference image is an image of an eye that is registered in dictionary data, and in the authentication processing, a similarity is calculated to compare the image of an eye of a person to be authenticated with images of eyes in dictionary data, to make a determination for facial recognition. Here, correspondence between an object image and a reference image means that the object image matches the reference image in similarity, but it may be determined that the object image matches the reference image not only when they perfectly match each other, but also when the number of matching points is more than or equal to a predetermined number.

The controller 135 outputs (feeds back), when the authentication processor 134 determines that the object image does not correspond to the reference image, coordinate information indicating the area of an object image to the image processing unit 12 to instruct the image processing unit 12 to change pixel values (process the object image). In addition, also when no feature spot is detected by the feature spot detecting unit 133, the controller 135 outputs the coordinate information indicating the area of an object image to the image processing unit 12 to instruct the image processing unit 12 to change pixel values of the object image. Here, the area of an object image indicated by the coordinate information may be the entire area of the object image, or may be an area of a feature spot when the feature spot is detected in the object image.

The pixel value controller 121 changes pixel values in an object image. If the authenticating unit 13 determines that the object image does not correspond to the reference image, the pixel value controller 121 changes pixel values corresponding to the coordinate information on the object image acquired from the controller 135. That is, the pixel value controller 121 changes the pixel values if the authenticating unit 13 cannot authenticates the similarity between the object image and the reference image. Namely, the pixel value controller 121 changes the pixel values when there is not the similarity between the object image and the reference image. In addition, the pixel value controller 121 changes pixel values corresponding to the coordinate information on an object image acquired from the controller 135 if the authenticating unit 13 detect no feature spot in an object image. The object image having the changed pixel values is output to the authenticating unit 13. Changing pixel values is, for example, to make the image clear by changing the luminance or contrast thereof. Note that not only the object image having the changed pixel values but also a captured image containing the object image having the changed pixel values may be output to the authenticating unit 13. In addition, if a feature spot is detected and the object image does not correspond to the reference image, pixel values in the coordinate region of the feature spot may be changed and the image of the feature spot may be output to the authenticating unit 13.

The authenticating unit 13 compares the object image the pixel values of which are changed based on the coordinate information with the reference image and performs the authentication processing again. The feature spot detecting unit 133 detects a feature spot in the object image. In addition, the authentication processor 134 performs the authentication processing on the object image the pixel values of which are changed. By performing the authentication processing on the object image the pixel values of which are changed, it is possible to increase a frequency at which a true authentication object is authenticated. Note that these steps of the authentication processing can be repeated until the object image matches the reference image.

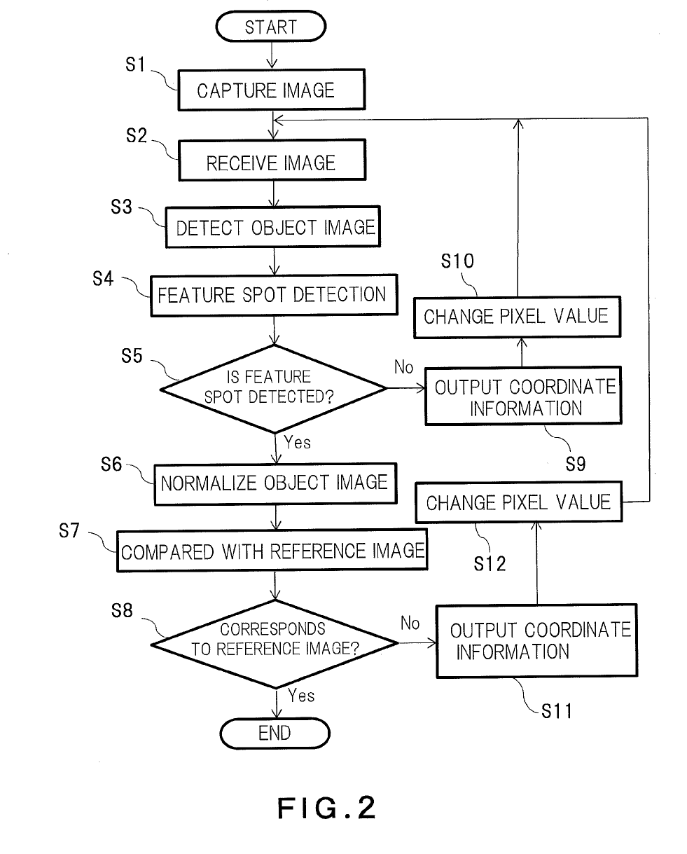

Next, an operation example of the image processing system 1 having the above-described configuration will be described with reference to FIG. 2. FIG. 2 is a flow chart showing the operation example of the image processing system 1.

As shown in FIG. 2, the image capturing unit 11 first captures an image of a subject (step S1). The image processing unit 12 performs a predetermined image processing on captured image data and outputs the captured image data to the authenticating unit 13.

Then, the image inputting unit 131 receives the captured image output from the image processing unit 12 (image reception) (step S2).

Then, the object image detecting unit 132 detects an object image from the captured image (step S3).

Then, the feature spot detecting unit 133 detects a feature spot in the object image (step S4).

Then, the authentication processor 134 judges whether a feature spot is detected (step S5). Then, if a feature spot is detected (step S5: Yes), the authentication processor 134 normalizes the object image based on the detected feature spot (step S6). The normalization may be, for example, a process of adjusting the angle (rotation) or the size (magnification) of the object image to the angle or the size of the reference image such that the object image can be compared with the reference image.

Then, the authentication processor 134 compares the normalized object image with the reference image stored in the storage unit 14 (step S7). The comparison may be a process of comparing the object image and the reference image to calculate the similarity of the object image with respect to the reference image. There is no limitation on a specific form of the similarity. For example, the authentication processor 134 may calculate the similarity based on the number of pixels in which the coordinates and the pixel values are identical to each other between the object image and the reference image.

Then, the authentication processor 134 determines (judges), based on the result of the comparison, whether the object image corresponds to the reference image (step S8). That is, the authentication processor 134 (authenticating unit 13) authenticates the similarity between the object image and the reference image. Then, if it is determined that the object image corresponds to the reference image (step S8: Yes), the process is finished. In this case, the image processing system 1 may transmit information indicating that the object image corresponds to the reference image (personal identification succeeds) to a security system (e.g., an entrance controlling system) that cooperates with the image processing system 1.

On the other hand, if no feature spot can be detected (step S5: No), the controller 135 outputs coordinate information indicating the area of the object image to the image processing unit 12 to instruct the image processing unit 12 to process the object image (step S9). Note that when there are a plurality of feature spots to be detected, it may be determined that the feature spots cannot be detected from the fact that at least one feature spot cannot be detected.

Then, the pixel value controller 121 changes pixel values of the object image in the area of the object image indicated by the coordinate information (step S10). At this point, the pixel value controller 121 may increase the luminance value of the object image or the contrast of the object image, in the area of the object image. In such a manner, by changing pixel values to part of a captured image based on coordinate information that indicates the area of an object image, it is possible to change the pixel values of the object image, simply, properly, and quickly.

Then, the image processing unit 12 outputs the object image the pixel values of which are changed to the authenticating unit 13. Alternatively, the object image may be output to the authenticating unit 13 in the form of a captured image that contains the object images the pixel values of which are changed. Thereafter, the process subsequent to the image reception (step S2) is repeated. Here, when only the object image is output from the image processing unit 12 to the authenticating unit 13, the object image detecting unit 132 does not need to detect the object image, enabling the process to be reduced in time.

In addition, if it is determined that the object image does not correspond to the reference image (step S8: No), the controller 135 outputs the coordinate information indicating the area of the object image to the image processing unit 12 (step S11). At this point, the controller 135 may output coordinate information that indicates the area of a feature spot in the object image.

Then, the pixel value controller 121 changes pixel values of the object image in the area of the object image indicated by the coordinate information (step S12). At this point, the pixel value controller 121 may increase the luminance value of the object image or the contrast of the object image, in the area of the object image. In such a manner, by changing pixel values to part of a captured image based on coordinate information that indicates the area of an object image, it is possible to change the pixel values of the object image, simply, properly, and quickly.

Then, the image processing unit 12 outputs the object image the pixel values of which are changed to the authenticating unit 13. Alternatively, the object image may be output to the authenticating unit 13 in the form of a captured image that contains the object images the pixel values of which are changed. Thereafter, the process subsequent to the image reception (step S2) is repeated. Here, when only the object image is output from the image processing unit 12 to the authenticating unit 13, the object image detecting unit 132 does not need to detect the object image, enabling the process to be reduced in time. In addition, if the image of only the area of the feature spot is output to the authenticating unit 13, the process in the object image detecting unit 132 and the feature spot detecting unit 133 can be eliminated, enabling the process to be further reduced in time.

Depending on the installation location of a camera apparatus or lighting conditions, the case may occur where an object image obtained by capturing an image of the same subject as that of the reference image is significantly different in pixel values. For example, dark lighting conditions at the time of capturing an image of a subject to be an object image cause the object image darker than a reference image. If the pixel values of an object image are significantly different from the pixel values of a reference image, the authentication processor 134 determines that the object image, which should be determined to correspond to the reference image, does not correspond to the reference image.

However, by changing the pixel values of the object image, there is a possibility that it is determined that the object image corresponds to the reference image. Consequently, it is possible to improve the frequency of authentications, that is, to reduce the occasions of erroneous authentication (rejection in identification) to a true authentication object, without recapturing the captured image. In addition, by making an image in which the luminance value or the contrast of an object image is increased, it is possible to further improve the frequency of authentications.

Depending on the installation location of a camera apparatus or lighting conditions, in some cases, although the object image is of the same subject as that of the reference image, the object image does not corresponds to the reference image because no feature spot can be detected in the object image.

However, by changing pixel values of the object image, there is a possibility of detecting a feature spot. Consequently, by changing the pixel values of the object image, it is possible to further improve the frequency of authentications, without recapturing the captured image.

Note that changing the pixel values and the authentication processing may be repeated until an object image corresponds to a reference image, but it is desirable that an upper limit is provided on the number of repetitions. By providing the upper limit on the number of repetitions, it is possible not to repeat useless authentication processing on an authentication object for which no reference image is registered.

As described above, according to the present embodiment, by changing the pixel values of the object image, it is possible to secure the authentication accuracy for an object image without recapturing a captured image regardless of the installed position of a camera apparatus or lighting conditions. It is thereby possible to relax the constraint on the installed position of a camera apparatus or lighting conditions and to improve the convenience of recognizing an object based on a captured image.

In addition, according to the embodiment, the authentication processing can be implemented with a single camera. If the authentication processing is implemented with a single camera, cost can be reduced and convenience can be improved as compared with the case where the authentication processing is implemented with a high-performance entertainment apparatus (middle- or large-scale server).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A semiconductor device comprising:
an image processing unit that acquires a captured image and is capable of changing a pixel value of the captured image; and
an authenticating unit that authenticates a similarity between an object image contained in the captured image and a reference image, wherein
the authenticating unit outputs coordinate information on the object image to the image processing unit, and authenticates the similarity between the object image, pixel values corresponding to the coordinate information on which are changed by the image processing unit, and the reference image.

2. The semiconductor device according to claim 1, wherein the pixel value is changed when there is not the similarity between the object image and the reference image.

3. The semiconductor device according to claim 1, wherein the authenticating unit detects a feature spot in the object image, the pixel value is changed when there is not the feature spot.

4. The semiconductor device according to claim 2, wherein the authenticating unit detects a feature spot in the object image, the pixel value is changed when there is not the feature spot.

5. The semiconductor device according to claim 1, wherein the image processing unit changes the pixel value to increase a luminance value or a contrast of the object image.

6. The semiconductor device according to claim 2, wherein the image processing unit changes the pixel value to increase a luminance value or a contrast of the object image.

7. The semiconductor device according to claim 3, wherein the image processing unit changes the pixel value to increase a luminance value or a contrast of the object image.

8. The semiconductor device according to claim 4, wherein the image processing unit changes the pixel value to increase a luminance value or a contrast of the object image.

9. A camera apparatus comprising:
an image capturing unit that captures an image of a subject; and
an authenticating unit that authenticates a similarity between an object image contained in a captured image captured by the image capturing unit and a reference image, wherein
the authenticating unit authenticates a similarity between an object image in which a pixel value is changed based on coordinate information on the object image contained in the captured image and the reference image, if there is not the similarity between the object image contained in the captured image and the reference image.

10. The camera apparatus according to claim 9, wherein the pixel value is changed when there is not the similarity between the object image and the reference image.

11. The camera apparatus according to claim 9, wherein the authenticating unit detects a feature spot in the object image, the pixel value is changed when there is not the feature spot.

12. The camera apparatus according to claim 10, wherein the authenticating unit detects a feature spot in the object image, the pixel value is changed when there is not the feature spot.

13. The camera apparatus according to claim 9, wherein the image processing unit changes the pixel value to increase a luminance value or a contrast of the object image.

14. The camera apparatus according to claim 10, wherein the image processing unit changes the pixel value to increase a luminance value or a contrast of the object image.

15. The camera apparatus according to claim 11, wherein the image processing unit changes the pixel value to increase a luminance value or a contrast of the object image.

16. The camera apparatus according to claim 12, wherein the image processing unit changes the pixel value to increase a luminance value or a contrast of the object image.
